(19) United States
(12) Patent Application Publication
(10) Pub. No.: US 2009/0319883 A1
(43) Pub. Date: Dec. 24, 2009

(54) Automatic Video Annotation through Search and Mining

(75) Inventors: Tao Mei, Beijing (CN); Xian-Sheng Hua, Beijing (CN); Wei-Ying Ma, Beijing (CN); Emily Kay Moxley, Santa Barbara, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,921

(22) Filed: Jun. 19, 2008

(51) Int. Cl. G06F 17/00; G06F 17/30

(52) U.S. Cl. 715/230; 707/3; 707/E17.014

(57) ABSTRACT

Described is a technology in which a new video is automatically annotated based on terms mined from the text associated with similar videos. In a search phase, searching by one or more various search modalities (e.g., text, concept and/or video) finds a set of videos that are similar to a new video. Text associated with the new video and with the set of videos is obtained, such as by automatic speech recognition that generates transcripts. A mining mechanism combines the associated text of the similar videos with that of the new video to find the terms that annotate the new video. For example, the mining mechanism creates a new term frequency vector by combining term frequency vectors for the set of similar videos with a term frequency vector for the new video, and provides the mined terms by fitting a zipf curve to the new term frequency vector.

### BACKGROUND

One of the ways in which uses can search for videos on the Internet is by video annotation (or tagging). In general, a user inputs one or more keywords, and then video annotations that have been built from text associated with the videos is matched with the keywords. Examples of text used in annotations may include a video's title and other text associated with that video (e.g., text such as a news story accompanying a video link) on a website.

Conventional approaches to video annotation predominantly focus on supervised identification of a limited set of concepts, including a limited vocabulary. However, this causes poor search results with respect to the relevance and/or relevant ordering of videos returned. By way of example, consider that the main topic of a video is a named individual who only recently has become recognized as noteworthy, which happens all the time in the news and other current events. If the annotations are not updated quickly as soon as that individual becomes known, videos will not be returned based on keyword searches that use that person's name, (unless coincidentally additionally-entered keywords make retrieval possible).

Although some video-oriented sites have user-generated tagging, such annotations are not quality-controlled. This results in the annotations being typically incomplete and/or noisy, that is, containing many incorrect keywords as well as missing vital keywords. An automatic, unsupervised way to annotate video, which is comprehensive and precise, is desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a new video is automatically annotated with terms mined from the text associated with similar videos. In one aspect, a set of videos are obtained that are similar to a new video, such as via searching via one or more search modalities. Text associated with the new video and with the set of videos is obtained, such as by automatic speech recognition that generates transcripts. A mining mechanism combines the associated text of the similar videos with that of the new video to find the terms that annotate the new video. For example, the mining mechanism creates a new term frequency vector by combining term frequency vectors for the set of similar videos with a term frequency vector for the new video, and provides the mined terms by fitting a zipf curve to the new term frequency vector.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an system for automatically annotating a new video based on similar videos via search and mining phases.

FIG. 2 is a block diagram representing results from example search modalities and combinations for fusing the results of different search modalities.

FIG. 3 is a flow diagram showing example steps taken to automatically annotate a new video via search and mining phases.

FIG. 4 shows an illustrative example of a computing environment into which various aspects of the present invention may be incorporated.

### DETAILED DESCRIPTION

Various aspects of the technology described herein are generally directed towards automatically annotating video by mining similar videos that reinforce, filter, and improve original annotations. In one aspect, a mechanism is described that employs a two-step process of search, followed by mining, e.g., given a query video of visual content and speech-recognized transcripts, similar videos are first ranked through a multi-modal search. Then, the transcripts associated with these similar videos are mined to extract keywords for the query.

It should be understood that any examples set forth herein are non-limiting examples. For example, the ways of obtaining visual, text, and concept features described herein are only some of the ways such features may be obtained. Additionally, mining for annotations is described via use of a zipf law, but mining is not limited to this example. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and content retrieval in general.

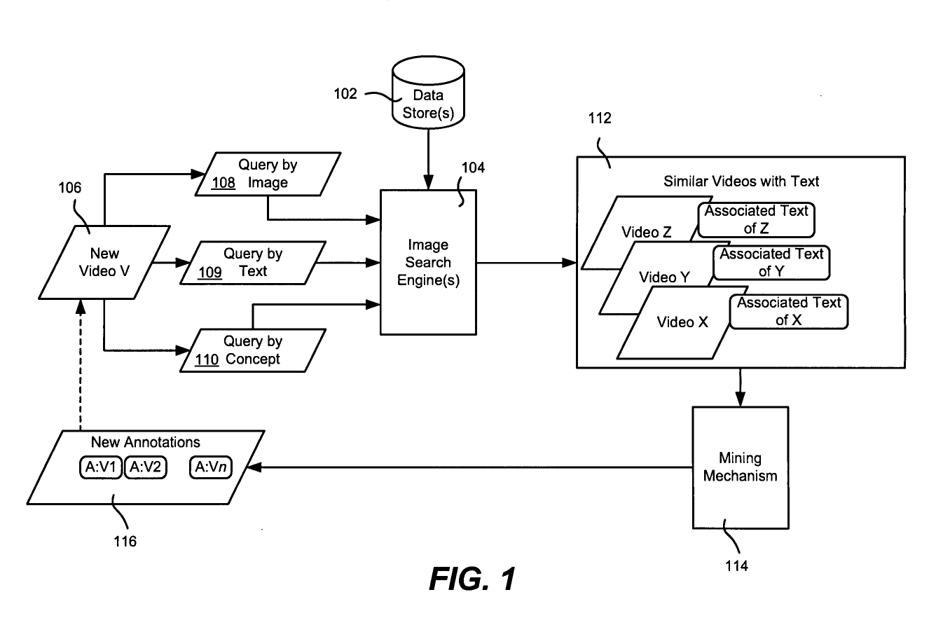

As generally represented in FIG. 1, there is shown a video annotation system including a data store or stores 102 that are searched in a search phase via one or more search engines 104 when given a new video 106. As described below, in one implementation, the search phase uses different search modalities for a video query, including query by video 108 (e.g., key frame searching and/or query by example, or QBE), query by text 109 (e.g., including a transcript) and query by concept 110 (e.g., using various classifiers/models) to determine a set 112 of similar videos with annotations.

Also represented in FIG. 1 is a mining mechanism 114, which in a mining phase, processes the annotations of the similar videos. The result of the mining is a set of annotations 116 that are then associated with the new video 106. In this manner, the new video is automatically annotated.

The search phase is directed towards finding videos whose content is similar to that of the queries generated from the new video, such that the words associated with the search results are associated to some extent with the video. The mining phase is directed towards further processing the words to find those words that appropriately annotate the original video, while discarding the others. As will be understood, the mining mechanism 114 described herein filters out noise, as relevant search results extracted in the mining step tend to be common among the various search modalities, while irrelevant search results tend to be different among the various search modalities.

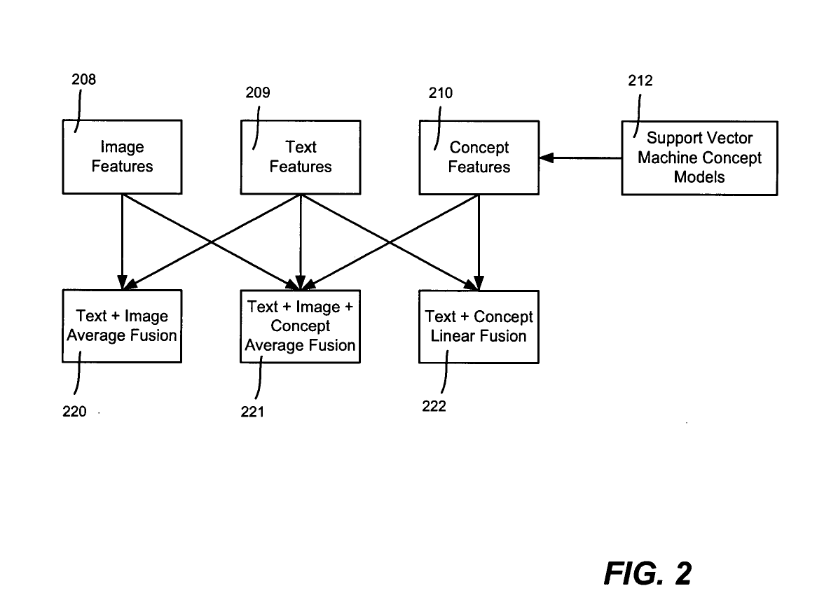

To this end, as generally represented in FIG. 2, there is described a robust fusion of the different modalities. The fusion provides a model that effectively annotates videos without relying on the analysis of the individual search modalities.

As represented in FIG. 2, the search modalities are based on image features 208, text features 209 and/or concept features 210. Further, combinations of those three modalities 220-222 may be used.

Image features 208 may be used alone to find and rank similar videos. Text features 209 may use automatic speech recognition (AST)/machine translated (MT) transcripts, as well as other associated text to find and rank similar videos. Concept features 210 are related to scores obtained from various support vector machine (SVM) models 212 where the concept scores are used to rank similar videos. For example, concept querying may use a 36-dimensional vector that is derived from image features only.

As also represented in FIG. 2, text and image modalities may be combined using average fusion 220; average fusion also may be used combines text, image, and concept modalities 221. Linear fusion may be used to combines text and concept modalities 222. Other ways to combine modalities may be used. As will be understood, any or all of these modalities and/or combinations of modalities may be used to obtain a set of similar videos based on searching.

With respect to obtaining the transcripts of similar videos, automatic speech recognition may be used for video annotation purposes similar to as is used for text annotation of documents. Note that the noise and errors in current automatic speech recognition/machine translation technology makes keyphrase extraction essentially impossible, because nearly any relevant phrase has an error in at least one of the words. However, as will be understood below, the mining technique described herein filters out such errors.

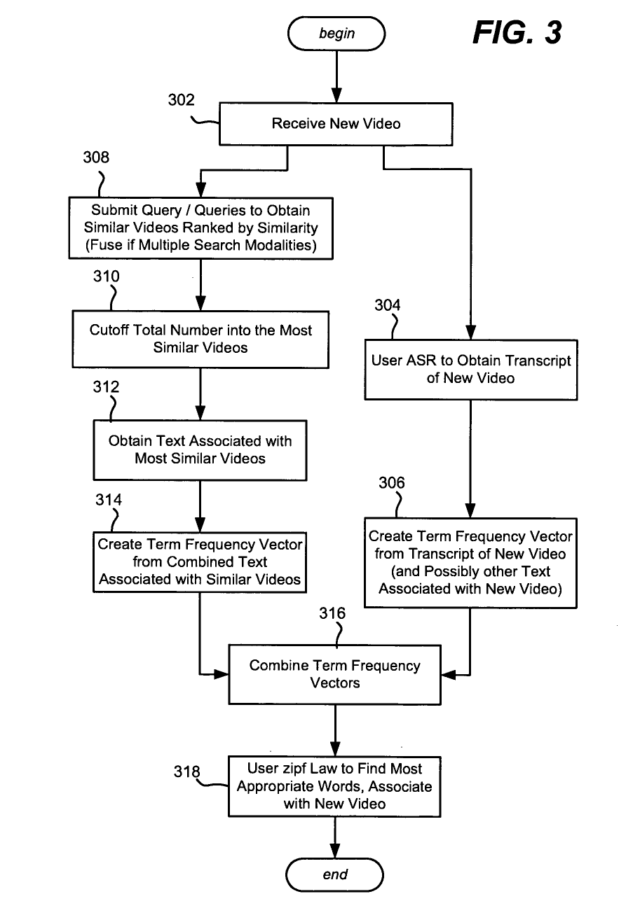

FIG. 3 described the overall process of searching and mining, beginning at step 302 which represents receiving a new video to process. Steps 304 and 306 represent the processing of the new video, e.g., obtaining its transcript via speech recognition, and creating a term frequency vector based on the frequency of each of the words in the transcript. Note that in one implementation, the term frequency vector occurs after stemming to convert words to their roots and stop-list processing to remove irrelevant words (like “the” and “and”). Further note that text other than the transcript may be used, e.g., the new video's title and/or description, if any, a text article appearing in conjunction with the video clip, and so forth.

Step 308 represents performing the search operations for similar videos, which may take place in parallel with the processing of the new video (steps 304 and 306). For the final search results, any of the modalities or fusion of modalities may be used, that is, video, text, concept, fused video and text, fused text and concept or fused video, text and concept.

Step 310 represents cutting off the search results to remove less similar videos (so that their text will not be considered, as described below). To this end, given a ranked list (a superset) from a specific search modality, a “most-similar” set T is extracted from the superset, in which T will be later used to supplement the query video's text. The cutoff for this set may be determined in various ways, including heuristically, but in general is applied uniformly for all search rankings. That is, videos are only considered sufficiently similar for inclusion if they were in the top percentage (e.g., half) of the range of the top N (e.g., 100) results. Shown mathematically, the indicator function for inclusion of a video i with a similarity score Si in the similar set T for mining is:

$$\begin{matrix}{I}_{i} \{ \begin{matrix}1 & if {S}_{i} \geq m , \\ 0 & if {S}_{i} < m\end{matrix} \\ where & ( 1 ) \\ m = {S}_{rank - 100} + α * ( {S}_{rank - 100} - {S}_{rank - 100} ) \\ and α = 0.5 in one example implementation . & ( 2 )\end{matrix}$$

Step 314 represents obtaining the text of the similar videos (in set T); note that if not already available for any given video, the transcript of that video may be automatically generated; also, additional associated text beyond the transcript may be part of each video's text. Given the text, after stemming and stop-list processing, a term frequency vector is created (step 314) for each of the video clips that represents the number of times each term is spoken in that video.

Step 316 represents combining the text terms based on frequency. In one implementation, two ways of weighing the automatic speech recognition results of the new video as supplemented by similar videos found via the search phase may be attempted. One way weighs a similar video i equally with the original video q, wᵢ=∀IεT (case 1). The second weighs the new video q with a weight of one, w_{q}=1, and weights each similar clip proportional to its similarity to the new video q (case 2). The resulting term frequency vector tf_{q} for query q is formulated as:

$${tf}_{q} = {\sum }_{i} {I}_{i} {w}_{i} {tf}_{i} \qquad ( 3 )$$

where for case 1, wᵢ=1, and for case 2,

$${w}_{i} = \{ \begin{matrix}1 & i = q , \\ \frac{{S}_{i}}{{\sum }_{i ∈ T} {S}_{i}} & i \neq q\end{matrix} . \qquad ( 4 )$$

Given the above, a zipf curve (zipf law mining) is fit to the term frequency vector by finding the best-fit shape parameter. As is known, the zipf curve models a typical distribution of word frequency in language. By finding the best-fit zipf curve, the mining mechanism 114 is able to determine an appropriate cutoff for the most important words, without assuming that a set of keywords have the same frequency. Those words are kept as keywords, such as those more frequent than the theoretical fifth-ranked word in the best-fit zipf curve.

As can be readily appreciated, the use of similar videos “corrects” for errors made in automatic speech recognition of the new video, by suppressing errors in the speech recognition for the new video. At the same time, the use of similar videos allows for discovery of new keywords not in the new video's transcript. Combining the term-frequency vectors (either in a weighted or un-weighted fashion) of similar videos with the data of the new video creates a new tf vector that provides more accurate, more complete annotations for associating with that new video.

### EXEMPLARY OPERATING ENVIRONMENT

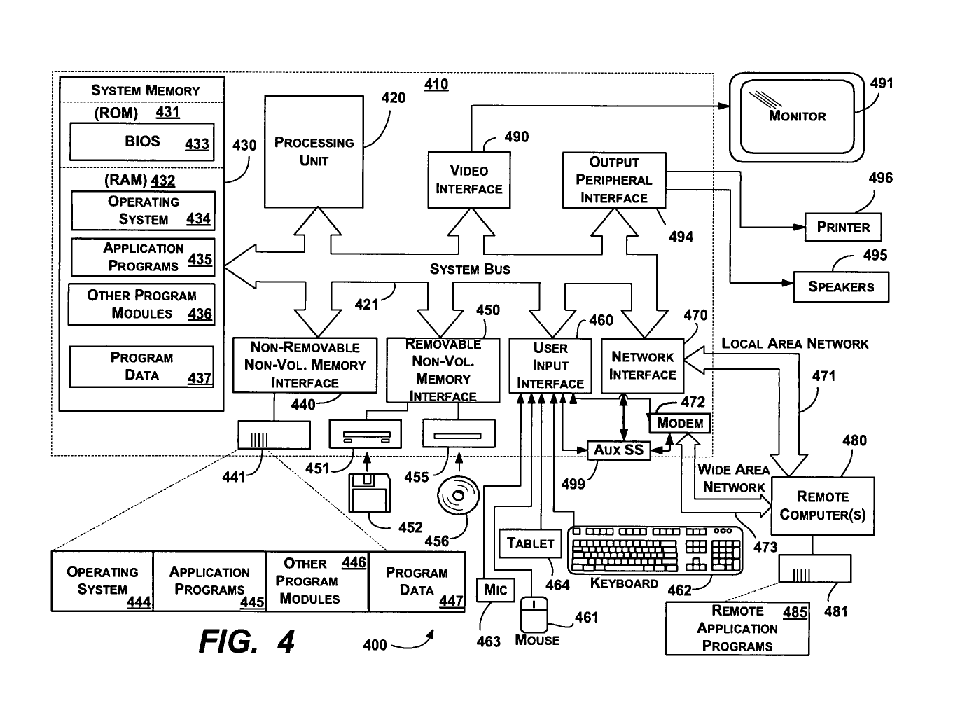

FIG. 4 illustrates an example of a suitable computing and networking environment 400 on which the examples and/or implementations of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, embedded systems, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 455 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 445 and program data 447. Note that these components can either be the same as or different from operating system 434, application programs 435, other program modules 435, and program data 437. Operating system 444, application programs 445, other program modules 445, and program data 447 are given different numbers herein to illustrate that, at a minimum, they are different copies. A user may enter commands and information into the computer 410 through input devices such as a tablet, or electronic digitizer, 454, a microphone 453, a keyboard 452 and pointing device 451, commonly referred to as mouse, trackball or touch pad. Other input devices not shown in FIG. 4 may include a joystick, game pad, satellite dish, scanner, or the like. These and other input devices are often connected to the processing unit 420 through a user input interface 450 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 495, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 450 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 450 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
obtaining a set of videos that are similar to a new video;
obtaining text associated with the new video;
obtaining text associated with the set of videos; and
using the text associated with the new video and the text associated with the similar videos to annotate the new video.

2. The method of claim 1 wherein obtaining the set of videos comprises searching for the set of videos via a text search, a concept search or an image search.

3. The method of claim 1 wherein obtaining the set of videos comprises searching for the set of videos via a combination of two or three search modalities, including a text search modality, a concept search modality or an image search modality.

4. The method of claim 1 wherein obtaining the set of videos comprises searching for a subset of the set of videos, and removing less similar videos from the subset to obtain the set of videos.

5. The method of claim 1 wherein obtaining the text associated with the new video comprises performing automatic speech recognition to obtain a transcript of words used in audio accompanying the new video.

6. The method of claim 1 wherein obtaining the text associated with the set of videos comprises performing automatic speech recognition to obtain a transcript of words used in audio accompanying at least one of the videos of the set of videos.

7. The method of claim 1 wherein using the text associated with the new video and the text associated with the similar videos to annotate the new video comprises mining annotations from the text associated with the new video and the text associated with the similar videos.

8. The method of claim 7 wherein mining the annotations comprises, creating a new term frequency vector based on frequencies of words associated with the new video and frequencies of words associated with the similar videos.

9. The method of claim 8 wherein the creating the new term frequency vector comprises combining term frequency vectors, including combining a term frequency vector created for each similar video with a term frequency vector created for the new video.

10. The method of claim 9 wherein combining the term frequency vectors includes weighing the term frequency vector of each similar video equally with the term frequency vector created for the new video.

11. The method of claim 9 wherein combining the term frequency vectors includes weighing the term frequency vector of each similar video based on its similarity to the new video.

12. The method of claim 8 wherein mining the annotations comprises fitting a zipf curve to the new term frequency vector.

13. In a computing environment, a system comprising:
a search phase comprising at least one search engine that searches at least one data store to obtain a set of videos that are similar to a new video; and
a mining phase including a mining mechanism that obtains text associated with the new video, obtains text associated with the set of similar videos, and annotates the new video by providing mined terms based at least in part on terms in the text associated with the similar videos.

14. The system of claim 13 wherein the search phase includes means for searching by text, means for searching by concept or means for searching by video, or means for searching by any combination of text, concept or image.

15. The system of claim 13 wherein the search phase includes means for fusing results of searching by text with searching by concept or searching by image, or means for fusing results of searching by text with searching by concept and searching by image.

16. The system of claim 13 wherein the mining mechanism creates a new term frequency vector by combining term frequency vectors for the set of similar videos with a term frequency vector for the new video.

17. The system of claim 16 wherein the mining mechanism provides the mined terms by fitting a zipf curve to the new term frequency vector.

18. One or more computer-readable media having computer-executable instructions, which when executed perform steps, comprising:
searching to determine a set of videos that are similar to a new video;
mining terms based upon a transcript of the new video and text associated with the set of similar videos; and
associating the terms with the new video.

19. The one or more computer-readable media of claim 18 wherein mining the terms comprises combining term frequency vectors for the set of similar videos with a term frequency vector for the new video.

20. The one or more computer-readable media of claim 19 wherein mining the terms comprises fitting a zipf curve to the new term frequency vector.
